(19) United States
(12) Patent Application Publication
(10) Pub. No.: US 2019/0364918 A1
(43) Pub. Date: Dec. 5, 2019

(54) CREAMERS COMPOSITIONS

(71) Applicant: NESTEC S.A., Vevey (CH)

(72) Inventors: Shuji Ota, Konolfingen (CH); Constantin Bertoli, Konolfingen (CH); Guillermo E. Napolitano, Dublin, OH (US); Peter Zeltner, Worblaufen (CH); Lucile Waksman, Bern (CH)

(21) Appl. No.: 16/462,808

(22) PCT Filed: Feb. 5, 2018
(86) PCT No.: PCT/EP2018/052766

§ 371 Date: May 21, 2019

Related U.S. Application Data
(60) Provisional application No. 62/456,187, filed on Feb. 8, 2017.

(51) Int. Cl. A23C 11/02; A23D 7/005

(52) U.S. Cl. CPC A23C 11/02; A23D 7/0053

(57) ABSTRACT

The present invention relates to a liquid and powder creamer composition comprising ultra-high oleic oils with an oleic acid content from 85 to 97% by weight of the total fatty acids in the creamer composition and oil soluble antioxidants. The invention also relates to a beverage composition comprising the liquid or powder creamer composition, and a method of making it.

### FIELD OF THE INVENTION

The present invention relates to liquid and powder creamers that may be used as such or for adding to coffee, tea, and cocoa and malted beverages, cereals, and to methods of producing creamers. In particular such creamer composition comprises ultra-high oleic oils with oleic acid content from 85 to 97% of the total fatty acids and an oil soluble antioxidant or a blend of different antioxidants.

### BACKGROUND

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, whitening, body, and a smooth texture. Creamers can be in liquid or powder forms. A liquid creamer may be intended for storage at ambient temperatures or under refrigeration, and should be stable during storage without phase separation, creaming, gelation, sedimentation or development of undesirable flavors. The creamer should also retain a constant viscosity over time. When added to cold or hot beverages such a coffee, tea, cocoa or malted variants the creamer should dissolve and disperse rapidly, provide a good whitening capacity, and remain stable with no feathering and/or sedimentation while providing a superior taste and mouthfeel.

Traditionally, fats and oils used in non-dairy liquid creamers have a high concentration of saturated and/or trans fatty acids. Both types of fatty acids, however, are known to increase the risk factors for cardiovascular and other chronic diseases. To avoid an increase in risk factors, non-dairy liquid and powder creamers have been made with healthier unsaturated oils. However, the creamers made with unsaturated oils have short shelf lives due to rapid oxidation and development of unpleasant off-flavors.

In the past, food companies used partially or fully hydrogenated oils to keep food shelf stable and avoid oxidative degradation. For this purpose food companies also used oils high in saturated fatty acids such as palm, coconut and palm kernel oils. All the oils mentioned above provided high amounts of trans and/or saturated fatty acids. More recently, non-dairy creamers are made by using oils high in oleic acid and low in alpha-linolenic acid for oxidation stability and nutritional purposes. These oils are often used in packaged baked goods (packaged cakes, cookies, etc.), as spray coating for cereals, crackers and dried fruits; and in non-dairy creamers as well as many types of frying.

In recent years, scientists have developed sunflower, safflower, canola (also known as rapeseed) and soybean oils containing high concentrations of monounsaturated fatty acids (MUFAs) and relatively low concentrations of polyunsaturated fatty acids (PUFAs) so they can be used in products that need to be shelf stable. Typical levels of MUFAs and PUFAs in these oils are 70 and 15%, respectively. This level of PUFAs still makes oils susceptible to oxidative degradation.

More recently, varieties of ultra-high oleic acids have been developed with levels of MUFAs, SFAs and PUFAs of about 90, 5% and 2% of the total fatty acids, respectively.

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. A powder creamer should exhibit emulsion stability during manufacturing and storage without oiling out or caking defects during storage. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel.

Coffee creamers containing healthier oils rich in unsaturated fatty acids are prone to oxidation and to the development of off-flavors. This problem is particularly prevalent in products expected to be shelf stable and stored at ambient temperatures.

WO/2011064167 discloses oxidative stability based on oil blends. The blend comprises at least one oil selected from the group consisting of coconut oil, palm oil, palm oil fractions, high oleic sunflower oil, and combinations thereof. The blend should comprise no more than 80% by weight saturated fatty acids, and no more than 1% by weight trans fatty acids.

Development of rancid or other off-flavors due to oxidation of the oil/fat component is a serious concern for the shelf-life of liquid creamers. Existing solutions include the use of fully or partially hydrogenated oils with a high content of saturated or trans fatty acids, respectively, and/or the use of artificial antioxidants. Partially hydrogenated oils are difficult to use in some markets due to very restrictive government regulations on trans fatty acids. On the other hand, fully hydrogenated oils are virtually free of trans fatty acids, but are undesirable as a product with hydrogenated oil may be perceived as being less healthy, less natural, and of a lower quality. Un-hydrogenated domestic commodity oils (such as soybean, canola and sunflower oils) have a tendency for rapid development of rancidity during storage.

The oxidation of oils in bulk and especially in oil in water emulsions is a very complex. Thus there is a need for creating non-dairy liquid creamers that are oxidative and emulsion stable for a required shelf-life. Furthermore such creamers may contain no or very low concentrations of trans fatty acids and moderate levels of unsaturated fatty acids.

The present invention combines the use of natural oil antioxidants to prevent the oxidation of oils in emulsions and powders.

### SUMMARY OF THE INVENTION

It was surprisingly found that natural oil soluble antioxidants when mixed with ultra-high oleic oils with oleic acid content from 85 to 97% of the total fatty acids exhibit an enhanced oxidative protective effect as compared to commodity or simply high oleic oils.

In one embodiment, the ultra-high oleic oils added to the creamer composition comprise linoleic acid in concentrations from 2 to 5% of the total fatty acids and alpha-linolenic acid at concentrations not exceeding 1% of the total fatty acids.

In a first aspect, the present invention relates to creamer compositions comprising ultra-high oleic oils, with an oleic acid content from 85 to 97% by weight of the total fatty acids in the creamer composition, and oil soluble antioxidants, wherein the high oleic oils comprise having polyunsaturated fatty acids below 5% of the total fatty acids.

In an embodiment, the creamer composition according to the invention comprises oil soluble tocopherols in a concentration between 100 mg/kg and 2000 mg/kg as oil soluble antioxidants. It has been found that the use of the antioxidants in the range between 100 and 1000 mg/kg in ultra-high oleic oils with oleic acid content from 85 to 97% of the total fatty acids provided an increase in oxidation stability which was greater than that produced in other high oleic oils.

An advantage of the present invention is to provide improved creamer compositions being free of trans fatty acids, good whitening capacity and are shelf stable without negative flavor perception during shelf-life. The creamers have a good appearance, aroma, flavor and texture after being stored at room or refrigeration temperature for an extended period of time. Another advantage of the present disclosure is to provide improved creamer compositions having low levels of saturated fatty acids.

Yet another advantage of the present disclosure is to provide creamers that are oxidatively stable in an emulsion and in a powder form.

In a second aspect, the invention relates to a method of producing a liquid creamer composition, the method comprising mixing a ultra-high oleic oil, a protein, low molecular weight emulsifiers, buffering agent(s), subjecting the mixture to ultra-high temperature (UHT) treatment, homogenizing and aseptically filling it into a package. In another aspect, the invention relates to a method of producing a powder creamer composition, the method comprising mixing a ultra-high oleic oil, a protein, a carbohydrate, low molecular weight emulsifier(s), buffering agent(s), subjecting the mixture to a heat treatment, homogenizing, spray drying and filling it into a package. It was found that adding a mixture of tocopherols to high oleic soybean oil produced only a modest increase in the oxidation stability of the oil (FIG. 1A). The addition of a total of 1000 mg/kg of tocopherols increased the oxidation stability by a factor of 1.5 compared to no antioxidant addition. Adding the same amount of the same mixture of tocopherols to an ultra-high oleic sunflower oil produced a much higher increase of the oxidative stability of the oil (FIG. 1B). The addition of a total of 1000 mg/kg of tocopherols to sunflower oil increased the oxidation stability by a factor of 2.4 compared to no antioxidant addition.

### BRIEF DESCRIPTION OF THE FIGURES

FIG. 1: HOSBO: high oleic soybean oil, HOSF: ultra-high oleic sunflower Induction period by the Rancimat apparatus (hours) of HOSBO (FIG. 1A) and HOSF (FIG. 1B) at 120° C. with several concentrations of mixed tocopherols.

FIG. 2: Sensory profile (mean value±standard deviation, n=8) of the creamer with the oil blend composed of a fully hydrogenated palm kernel oil and high oleic algal oil (67/33% by weight) with 1000 mg/kg of added mixed natural tocopherols versus a creamer with a fully hydrogenated palm kernel oil.

FIG. 3 Sensory evaluation of powder creamers stored 12 months at 30° C. and 37° C., dissolved in coffee. Mean value±standard deviation, n=5).

FIG. 4: Sensory profile (mean value±standard deviation, n=10) of the creamer with the oil blend composed of a fully hydrogenated palm kernel oil and high oleic soybean oil (66/34% by weight) with 100 mg/kg of mixed natural tocopherols versus a creamer with a fully hydrogenated palm kernel oil.

### DETAILED DESCRIPTION OF THE INVENTION

According to the present invention creamer compositions are provided which have a good chemical stability. By chemical stability is meant resistance to oxidation in an amount that it deteriorates the product. In addition to the above the present invention provides creamer compositions with good physical stability.

By a creamer composition is meant a composition that is intended to be added to a food composition, such as, e.g. coffee or tea, to impart specific characteristics such as color (e.g. whitening effect), thickening, flavour, texture, and/or other desired characteristics. By oil soluble antioxidants is meant that the antioxidant is freely dissolved in oil but does not dissolve in water.

Tocopherols are mixes of natural tocopherols extracted from oil seeds and rich in the gamma-tocopherol homolog.

The term “ultra-high oleic oils” refers to oils with oleic acid content between 85 to 97% of total fatty acids. This term includes oils such as new varieties of sunflower oil and algal oils (example sold under the brand name TerraVia AlgaWise®). Such oils termed as “ultra-high oleic oils” in general have depleted amounts of tocopherols in particular depleted in the gamma-tocopherol homolog. This term does not include other oils such as high oleic soybean and canola which are already enriched in the gamma-tocopherol homolog.

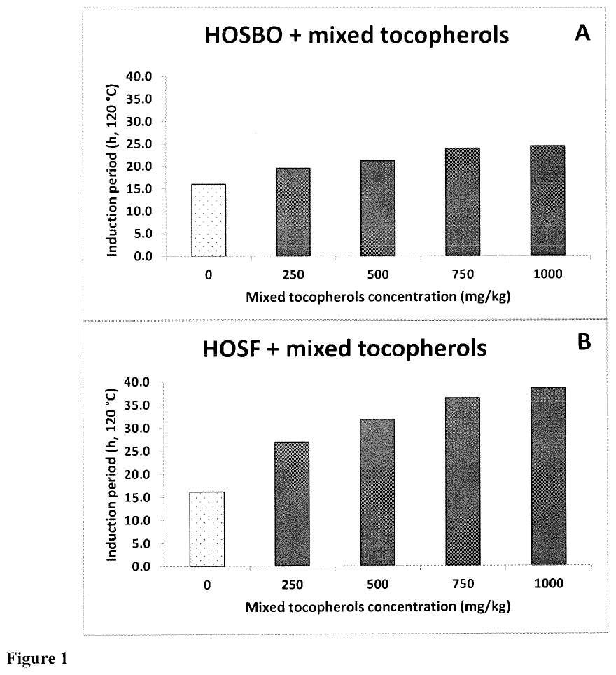

The surprising finding is that external addition of tocopherols to unsaturated ultra-high oleic oils enhances the oxidation stability (refer to FIG. 1). FIG. 1A shows that the oxidation stability has approached its saturation point at 750 mg/kg of tocopherol addition to high oleic oils (e.g. soybean oil), while on the other hand the oils of the present invention show an enhanced response in oxidation stability upon external addition of tocopherols to the ultra-high oleic oils.

For the best mouthfeel, and physico-chemical properties as such and when added to hot coffee, the creamer composition comprises any of the preceding claims comprising between about 2% and about 55% oil.

Preferably, the unsaturated oil comprises a vegetable oil selected from the group consisting of high oleic canola, high oleic soybean oil, high oleic sunflower, high oleic safflower or a combination thereof.

In the present context a full fat liquid creamer comprises above 6% fat while a low fat creamer comprises below 4% fat.

Further in the present context unless otherwise indicated % of a component means the % of weight based on the weight of the creamer composition, i.e. weight/weight %.

In a preferred embodiment of the invention the oil soluble antioxidant is selected from the group consisting of tocopherols extracted from soybean, sunflower and or rapeseed/canola oils or combinations thereof. The oil soluble antioxidants are preferably added before the oil is shipped to the factory for production. The oil soluble antioxidants will protect the oil during transportation and storage before production and also provide protection of the oil phase during manufacturing and shelf-life of the product. These oil soluble antioxidants do not need additional additives, such as emulsifiers or dispersants to be fully effective. According to the present invention all antioxidants are of natural origin derived from plant or seed extracts.

It is known that oil oxidation in creamers is delayed by using some oil soluble antioxidants. Given the fact that tocopherols are known to have a low antioxidant effect in oil-in-water emulsions, it is not often foreseen to be added to creamer compositions. However, in the present invention, it was unexpectedly found that tocopherols exhibited an enhanced protective effect when mixed with ultra-high oleic oils. For example, tocopherols work particularly well with ultra-high oleic sunflower oil and high oleic algal oils in preventing oxidation and development of rancid flavor in creamers.

The liquid creamer composition of the invention preferably comprising between about 0.1% and about 1.5% protein by weight of the creamer composition. The use of proteins in amount of less than 0.1% did not provide stable emulsion in liquid creamers, while addition of proteins in amount above 1.5% resulted in sedimentation during storage.

The creamer composition of the invention further comprises protein, preferably between about 0.1% (weight/weight) and about 1.5% protein, such as between about 0.2% (weight/weight) and about 1.3% protein, more preferably between about 0.5% (weight/weight) and about 1% protein. The protein may be any suitable protein, e.g. milk protein, such as casein, caseinate, and whey protein; vegetable protein, e.g. soy and/or pea protein; and/or combinations thereof. The protein is preferably sodium caseinate. The protein in the composition may work as an emulsifier, but may also provide texture, and/or provide whitening effect. Too low levels of protein reduce the stability of the liquid creamer and creaming may occur. At high protein levels phase separation occurs in creamer as is and especially when the creamer is added to hot coffee. Moreover, a high level of proteins cause feathering when added to coffee prepared with hard water.

In one embodiment of the invention, the creamer composition is a powder comprising between about 0.1% and about 5.5% protein by weight of the creamer composition. The use of proteins in amount of less than 0.1% did not provide a stable emulsion for spray drying and caused fat separation on reconstitution of the powder creamers.

Advantageously, the creamer composition according to the invention comprises emulsifiers that are low molecular weight emulsifiers and ranging from about 0.2 to about 2% by weight.

In one embodiment of the invention, the creamer composition is devoid of added low molecular weight emulsifiers. By a low molecular weight emulsifier is meant an emulsifier with a molecular weight below about 1500 g/mol. Emulsions are thermodynamically unstable, and the phases of an emulsion will separate with time. By an emulsifier is meant a compound that stabilises the interface between the two phases of the oil-in-water emulsion and reduces the rate of phase separation. By the term “devoid of added low molecular emulsifiers” is meant that the creamer composition does not contain any low molecular emulsifiers which have been added in amounts sufficient to substantially affect the stability of the emulsion. A creamer composition devoid of added low molecular emulsifiers may contain minor amounts of low molecular emulsifiers which do not substantially affect the stability of the emulsion, but which are present e.g. as minor impurities of one or more of the ingredients of the creamer composition.

Low molecular weight emulsifiers include, but are not limited to monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of monoglycerides and diglycerides, lactic acid esters of monoglycerides and diglycerides, lecithins, lysolecithins, and sucrose esters of fatty acids.

In one embodiment a creamer composition according to the invention is devoid of added monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides and diglycerides, succinic acid esters of monoglycerides and diglycerides, lactic acid esters of monoglycerides and/or diglycerides, and sucrose esters of fatty acids.

The creamer composition of the present invention may further include a buffering agent. The buffering agent can prevent undesired creaming or precipitation of the creamer upon addition to a hot, acidic environment such as coffee. The buffering agent can, e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer may, e.g. be present in an amount of about 0.1 to about 1% by weight of the liquid creamer.

The creamer composition of the present invention may further include one or more additional ingredients such as flavors, sweeteners, colorants, antioxidants (e.g. lipid antioxidants), or a combination thereof. Sweeteners can include, for example, at least one second sweetening agent selected in, but not limited to, the list of:
(i) natural sweeteners such as Momordica grosvenori (Mogrosides IV or V), Stevia (Rebaudiosides A, B, C, D, E, F, . . . , M), Thaumatin, Brazzein, glycyrrhyzic acid and its salts, Curculin, Monellin, Phylloducin, Rubusosides, Mabinlin, dulcoside A, dulcoside B, stevioside, siamenoside, monatin and its salts (monatin SS, RR, RS, SR), hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, erythritol, and/or other natural polyols such as maltitol, mannitol, lactitol, sorbitol, inositol, Isomalt, xylitol, glycerol, propylene glycol, threitol, galactitol, reduced isomalto-oligosaccharides, palatinose, reduced xylo-oligosaccharides, reduced gentio-oligosaccharides, reduced maltose syrup, or reduced glucose syrup, or a mixture thereof, and/or
(ii) artificial sweeteners, such as Aspartame, Cyclamate, Sucralose, Acesulfame K, neotame, Alitame, Saccharin, Neohesperidin dihydrochalcone, or mixtures thereof.

In a further preferred embodiment of the present invention, the food composition further comprises mixtures of the above natural and/or artificial sweeteners, and sweet taste improving carbohydrates. These may include, but are not limited to, sucrose, fructose, glucose, maltose, lactose, mannose, galactose, ribose, rhamnose, trehalose, tagatose, allulose, allose, isomaltulose and other rare sugars, high fructose corn syrup (HFCS), maltose, maltodextrins, resistant dextrins, inulin and fructooligosaccharides, polydextrose, levulose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination.
In a further preferred embodiment of the present invention, the food composition further comprises mixtures of the above natural and/or artificial sweeteners, sweet taste improving carbohydrate and flavors enhancing the sweetness such as Positive Allosteric Molecules (PAMs), sweet enhancers or taste modifiers.
Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In one embodiment, a sweetener is present in the creamer composition of the invention at a concentration ranging from about 5% to about 40% by weight. In another embodiment, the sweetener concentration ranges from about 25% to about 30% by weight.

The invention further relates to a method of producing a creamer composition of the invention. The method comprises providing a composition, the composition comprising water, high oleic oils, proteins, emulsifiers, buffers and optionally, sugars, flavors, colors, vitamins and minerals.

Before homogenisation, optional ingredients and additives such as, hydrocolloids, sweeteners and/or flavors may be hydrated in water (e.g., at between 40° C. and 90° C.) under agitation, with addition of oil if desired. The method may further comprise heat treating the composition before homogenisation, e.g. by aseptic heat treatment. Aseptic heat treatment may use direct or indirect UHT processes. UHT processes are known in the art. Examples of UHT processes include UHT sterilization and UHT pasteurization. Direct heat treatment can be performed by injecting steam into the emulsion. In this case, it may be necessary to remove excess water, for example, by flashing. Indirect heat treatment can be performed with a heat transfer interface in contact with the emulsion. The homogenization may be performed before and/or after heat treatment. It may be advantageous to perform homogenization before heat treatment if oil is present in the composition, in order to improve heat transfers in the emulsion, and thus achieve an improved heat treatment. Performing a homogenization after heat treatment usually ensures that the oil droplets in the emulsion have the desired dimension. After heat treatment the product may be filled into any suitable packaging, e.g. by aseptic filling. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 to Taggart, which are incorporated herein by reference. In an embodiment, the method comprises heat treating the liquid creamer before filling the container. The method can also comprise adding a buffering agent in amount ranging from about 0.1% to about 1.0% by weight to the liquid creamer before homogenizing the liquid creamer. The buffering agent can be one or more of sodium mono- and di-phosphates, potassium mono- and di-phosphates, sodium mono- and bi-carbonates, potassium mono- and bi-carbonates or a combination thereof. As an alternative to the aseptic filling, extended shelf-life treatment can be used should the products be stored only at refrigeration (usually up to 6 months), while with aseptic filling the product can be stored at ambient temperatures.

The creamer, when added to a beverage, produces a physically stable, homogeneous, whitened drink with a good mouthfeel, and body, smooth texture, and a pleasant taste with no off-flavors notes. The use of the creamer of the invention is not limited for only coffee applications. For example, the creamer can be also used for other beverages, such as a coffee, tea, malt, cereal, or cocoa beverage composition, or used with cereals or berries, as a creamer for soups, and in many cooking applications, etc. A liquid creamer of the invention is preferably physically stable and overcome phase separation issues (e.g., creaming, plug formation, gelation, syneresis, sedimentation, etc.) during storage at refrigeration temperatures (e.g., about 4° C.), room temperatures (e.g., about 20° C.) and elevated temperatures (e.g., about 30° C. to 38° C.). The stable liquid creamers can have shelf-life stability such as at least 6 months at 4° C. and/or at 20° C., 6 months at 30° C., and 1 month at 38° C. Physical stability may be evaluated by visual inspection of the product after storage.

The invention in an even further aspect relates to a beverage composition comprising a creamer composition as disclosed above. A beverage composition may, e.g. be a coffee, tea, malt, cereal or cocoa beverage. A beverage composition may be liquid or in powder form. Accordingly, the invention relates to a beverage composition comprising a) a creamer composition of the invention, and b) a coffee, tea, malt, cereal, or cocoa product, e.g. an extract of coffee, tea, malt, or cocoa. If the beverage composition is in liquid form it may, e.g. be packaged in cans, glass bottles, plastic bottles, or any other suitable packaging. The beverage composition may be aseptically packaged. The beverage composition may be produced by a method comprising a) providing a beverage composition base; and b) adding a creamer composition according to the invention to the beverage composition base. By a beverage composition base is understood a composition useful for producing a beverage by addition of a creamer of the invention. A beverage composition base may in itself be suitable for consumption as a beverage. A beverage composition base may, e.g. be an extract of coffee, tea, malt, or cocoa.

A liquid creamer of the invention has good whitening capacity and is also stable (without feathering, de-oiling, other phase separation defects) when added to hot beverages (coffee, tea and like), even when coffee is made with hard water, and also provides good mouthfeel.

### EXAMPLES

By way of example and not limitation, the following examples are illustrative of various embodiments of the present disclosure.

It should be understood that various changes and modifications to the presently preferred embodiments described herein will be apparent to those skilled in the art.

Such changes and modifications can be made without departing from the spirit and scope of the present subject matter and without diminishing its intended advantages. It is therefore intended that such changes and modifications be covered by the appended claims.

### Example 1

A dry blend of 10 g of sodium caseinate with 250 g of sucrose was added to the tank of hot water with above stabilizers under high agitation. After 10 minutes of mixing, emulsifiers (10 g of monoglycerides and diglycerides and 30 g of diacetylated tartaric acid esters of monoglycerides and diglycerides) were added into the tank under continuous agitation. Further, 800 g of ultra-high oleic sunflower oil containing the oil soluble antioxidant (1000 mg/kg) was added under agitation. Then, a small amount of remained water was added to adjust the total product amount to 10 kg.

The liquid was pre-heated, UHT treated for 5 sec at 143° C., homogenized at 150/50 bar, cooled and the liquid creamer was aseptically filled into bottles. (Liquid creamers can be aseptically filled in any aseptic containers, e.g. jars, jugs or pouches).

The liquid creamer was stored 1 month at 38° C., 3 months at 30° C. and 6 months at 20° C.

No phase separation (creaming, de-oiling, marbling, etc.), gelation, sedimentation and practically no viscosity changes were found during the storage. Further, the creamer showed a homogeneous product without phase separation with good whitening capacity when added to a coffee.

Sensory of the creamer and hot coffee beverage with added liquid creamer was judged by trained panellists. It was found that the liquid creamer had good appearance, mouthfeel, smooth texture and a good flavor without off-taste after storage of 1 month at 38° C., 3 months at 30° C. and 6 months at 20° C.

### Example 2

A liquid creamer was prepared as in Example 1 but using a high oleic algal oil instead of sunflower oil.

No phase separation (creaming, de-oiling, marbling, etc.), gelation, sedimentation and practically no viscosity changes were found during the storage. Further, the creamer showed a homogeneous product without phase separation with good whitening capacity when added to a coffee.

Sensory of creamer and hot coffee beverage with added liquid creamer was judged by trained panelists. It was found that the liquid creamer had good appearance, but oxidized flavor and off-taste after storage 1 month at 38° C.

Accordingly, a creamer prepared with ultra-high oleic oil and 1000 mg/kg of mixed tocopherols has an acceptable sensory score at the end of shelf-life, when a creamer prepared with high oleic soybean oil with the same concentration of tocopherol shows unacceptable sensory scores Table 1).

TABLE 1
Sensory scores at the end of shelf-life of coffee creamer products made
with different oils and added antioxidants (scale 1-10; values < 6 are
unacceptable).

| | Sensory score | |
|---|---|---|
| | 100 mg/kg | 1000 mg/kg |
| | mixed tocopherols | mixed tocopherols |
| Oil type | added | added |
| High oleic canola oil | 5 | 5 |
| High oleic soybean oil | 4.8 | 5 |
| High oleic algal oil | — | 8 |

### Example 3

5.2 kg of fully hydrogenated palm kernel oil was heated up to 55° C. in a vessel. Emulsifiers (23 g of diacetylated tartaric acid esters of monoglycerides and diglycerides and 92 g of distilled monoglycerides) were added to the tank and mixed for 10 minutes to dissolve in the oil.

17.6 kg of water was heated up to 65° C. in a separate tank. 140 g of sodium hexametaphosphate and 288 g of dipotassium phosphate were added to the tank and mixed for 1 minute. 552 g of sodium caseinate was added to the tank and mixed with high agitation. After 15 minutes 13.9 kg of dehydrated glucose syrup was added to the tank and mixed for 5 minutes. After that fully hydrogenated palm kernel oil and emulsifiers prepared in the vessel were added to the tank and mixed for 5 min. Then, 2.6 kg of high oleic algal oil with added 1000 mg/kg of mixed natural tocopherols was added to the tank and mixed for 1 min.

The concentrate was heated up for pasteurization in a holding tube (at 76° C. for 35 sec), homogenized at 210/40 bar and spray dried.

The powder was filled into metal cans without N₂ gassing.

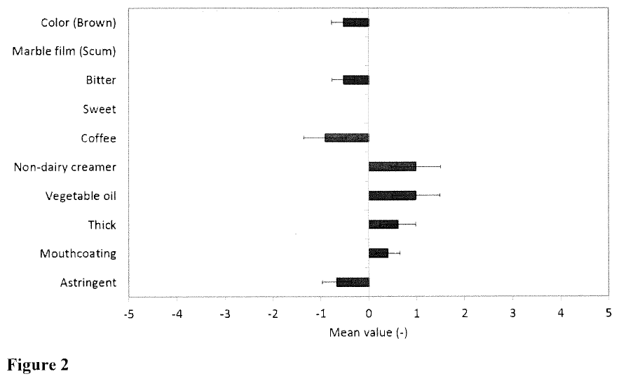

Comparative sensory profiling of hot coffee beverage with added powder creamer was performed by trained panellists. The reference creamer was prepared the same way but using a fully hydrogenated palm kernel oil instead of the oil blend of a fully hydrogenated palm kernel oil and high oleic algal oil. SFA content of the sample was 22.3 g/100 g creamer and SFA content of the reference creamer was 31.6 g/100 g creamer. The sensory profile was very close to the reference creamer even though the SFA content of the sample is 29% less than the reference. The FIG. 2 shows the sensory profile. The creamer with the oil blend (a fully hydrogenated palm kernel oil and high oleic algal oil with 1000 mg/kg of mixed natural tocopherols) had just a little more non-dairy creamer note, vegetable oil note, thickness and mouth coating. It had just a little less brown color, bitterness and astringency. Sensory score of each attribute was within −1 and +1. So the overall sensory profile was very close to the reference creamer.

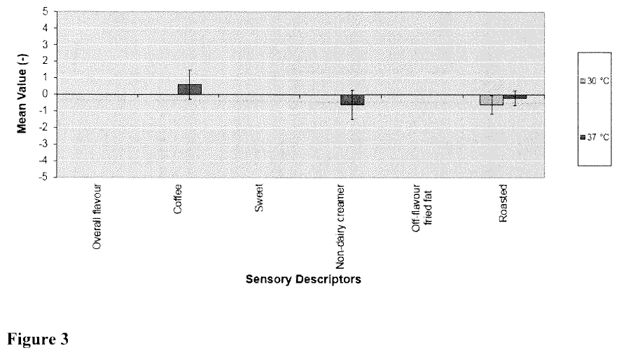

The creamer was stored 12 month at 4° C., 30° C. and 37° C. Sensory of hot coffee beverage with added powder creamer was judged by trained panellists. The samples stored at 30° C. and 37° C. were compared with a reference sample (the sample which was stored at 4° C.). The FIG. 3 shows the result. It was found that the powder creamer without N₂ gassing in a final packaging had good appearance, mouth-feel, smooth texture and a good flavor without off-taste after storage 12 month at 30° C. and 37° C.

Based on a meta-analysis of 60 controlled trials published by R. Mensink et al. (Am. J. Clin. Nutr. 77(5), 1146-1155, 2003 and http://ajcn.nutrition.org/content/77/5/1146.full.pdf+html&quot;&gt) it could be shown that an oil blend of fully hydrogenated palm kernel oil (67% by weight) and high oleic algal oil (33% by weight) clearly predicted a lower risk of cardiovascular disease than pure hydrogenated palm kernel oil.

### Example 4

A powder creamer was prepared as in Example 3 but using high oleic soy bean oil instead of high oleic algae oil.

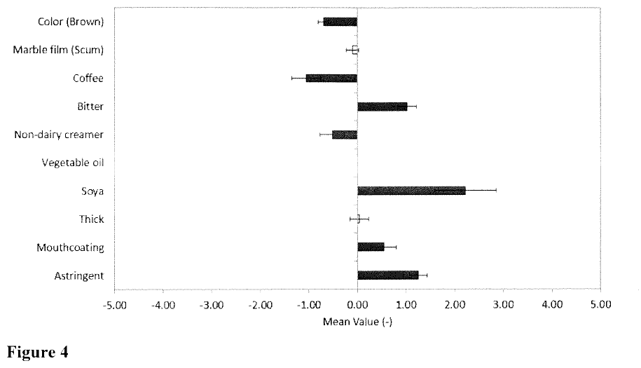

Comparative sensory profiling of hot coffee beverage with added powder creamer was performed by trained panellists. SFA content of the sample was 22.4 g/100 g creamer and SFA content of the reference creamer was 31.6 g/100 g creamer. The FIG. 4 shows the sensory profile of the hot beverage. The hot beverage with the creamer based on the oil blend composed of fully hydrogenated palm kernel oil and high oleic soybean oil stabilized with 100 mg/kg of mixed natural tocopherols had slightly more soya note, a little more bitterness, mouth coating and astringency compared to the reference sample. It also had a little less brown color, coffee and non-dairy creamer flavor.

Compared to the sensory profile of the creamer with high oleic algal oil shown in example 3, the sensory profile was not close to the reference creamer.

The creamer (fully hydrogenated palm kernel oil and high oleic soybean oil) was stored 15 month at 4° C., 30° C. and 37° C. Sensory of hot coffee beverage with added powder creamer was judged by trained panellists. The samples stored at 30° C. and 37° C. were compared with a reference sample (the sample which was stored at 4° C.). After storage 15 month at 30° C. and 37° C. the samples were evaluated as “Out” due to off-taste compared to the reference sample.

1. A creamer composition comprising ultra-high oleic oils, with an oleic acid content from 85 to 97% by weight of the total fatty acids in the creamer composition; and oil soluble antioxidants.

2. The creamer composition according to claim 1, wherein the ultra-high oleic oils comprises linoleic acid in concentrations from 2 to 5% and alpha-linolenic acid at concentrations not exceeding 1% of the total fatty acids.

3. The creamer composition according to claim 1, wherein the oil soluble antioxidant comprises tocopherols.

4. The creamer composition according to claim 3, wherein the tocopherols are at least 50 mg/kg.

5. The creamer composition according to claim 1, wherein the ultra-high oleic oil is selected from the group consisting of high oleic sunflower, high oleic algal oils and combinations thereof.

6. The creamer composition according to claim 3, wherein the oil soluble antioxidant is selected from the group consisting of tocopherols which are extracted from soybean, rapeseed oils, and combinations thereof.

7. The creamer composition according to claim 1 wherein the amount of oil in the creamer composition is between 2 and 55% by weight of the creamer composition.

8. The creamer composition according to claim 1 further comprises a protein at a concentration between 0.1% and 5% by weight of the creamer composition.

9. The creamer composition according to claim 1, comprising emulsifiers ranging from about 0.2 to about 2% by weight of the creamer composition.

10. A beverage composition comprising a creamer composition comprising ultra-high oleic oils, with an oleic acid content from 85 to 97% by weight of the total fatty acids in the creamer composition and oil soluble antioxidants.

11. The beverage composition of claim 10 wherein the beverage is selected from the group consisting of a coffee, tea, malt, cereal, cocoa beverage composition, a nut based milk and coconut based milk.

12. (canceled)

13. A method of preparing a beverage composition, the method comprising:
providing a beverage composition base; and
adding a liquid creamer composition comprising ultra-high oleic oils, with an oleic acid content from 85 to 97% by weight of the total fatty acids in the creamer composition and oil soluble antioxidants to the beverage composition base.

14-15. (canceled)
